(19) United States
(12) Patent Application Publication
(10) Pub. No.: US 2019/0184687 A1
(43) Pub. Date: Jun. 20, 2019

(54) LAMINATED STRUCTURE

(71) Applicant: FUJIFILM CORPORATION, Tokyo (JP)

(72) Inventors: Hideki YASUDA, Kanagawa (JP); Hirotoshi YOSHIZAWA, Kanagawa (JP); Tatsuya YOSHIHIRO, Kanagawa (JP)

(21) Appl. No.: 16/285,219

(22) Filed: Feb. 26, 2019

Related U.S. Application Data
(63) Continuation of application No. PCT/JP2017/035673, filed on Sep. 29, 2017.

(30) Foreign Application Priority Data
Sep. 30, 2016 (JP) 2016-194975

(51) Int. Cl. B32B 27/08; B32B 27/36; B32B 27/32; B32B 27/30; B32B 27/06; B32B 5/18; B32B 7/12

(52) U.S. Cl. CPC B32B 27/08; B32B 27/365; B32B 27/32; B32B 27/302; B32B 2266/0264; B32B 5/18; B32B 7/12; B32B 2307/304; B32B 2307/416; B32B 27/065

(57) ABSTRACT

According to an embodiment of the invention, there is provided a laminated structure including, in this order from a side nearer to an object to be cooled: a radiative cooling layer which contains a bubble-containing resin and radiates far-infrared rays to cool the object to be cooled; and a heat insulating layer which contains a bubble-containing resin and has a porosity of 70% or more and in which the number of bubbles contained in a layer thickness direction is 8 or less.

### CROSS-REFERENCE TO RELATED APPLICATIONS

This application is a continuation application of International Application No. PCT/JP2017/035673, filed Sep. 29, 2017, the disclosure of which is incorporated herein by reference in its entirety. Further, this application claims priority from Japanese Patent Application No. 2016-194975, filed Sep. 30, 2016, the disclosure of which is incorporated herein by reference in its entirety.

### BACKGROUND OF THE INVENTION

### 1. Field of the Invention

The present disclosure relates to a laminated structure.

### 2. Description of the Related Art

Radiative cooling is a commonly known natural phenomenon. Using a cooling technology utilizing radiative cooling has been expected from the viewpoint of energy saving and the like.

A wall structure in which a first heat insulating layer made of a white acrylic resin material having a high sunlight reflectivity and a high infrared emissivity in a wavelength range of 8 to 13 μm is provided on the surface side of a wall material, and a second heat insulating layer made of polyethylene foam having a low thermal conductivity and a high infrared transmittance in a wavelength range of 8 to 13 μm is provided on the first heat insulating layer has been disclosed (for example, JP4743365B).

In addition, technologies for realizing daytime radiative cooling by reflecting sunlight by a HfO₂/SiO₂/Ag lamination film, radiating far-infrared rays by the HfO₂/SiO₂/Ag lamination film in a similar manner, and suppressing heat inflow from the surroundings by an air layer have been proposed (for example, see the specification of US2015/0338175A1).

### SUMMARY OF THE INVENTION

As described above, the technologies for preventing heat inflow by reflecting sunlight, or the technologies for exhibiting a heat insulating function by providing an air layer have been proposed and used in the past. For example, as disclosed in JP4743365B, in a laminated structure in which a heat insulating layer having a low thermal conductivity is provided on a layer having a high sunlight reflectivity and a high infrared emissivity, a radiative cooling function is provided on the lower layer side, and a heat insulating function is provided on the upper layer side to suppress intrusion of thermal energy into the inside.

Cooling structures in which a radiative cooling structure and a heat insulating structure are laminated as above have been known. In this case, the cooling is realized based on the following principles.

1. Reflecting sunlight, and suppressing heat inflow

2. Radiating heat as far-infrared rays, and releasing heat of an object to be cooled to the outside

3. Suppressing heat inflow from the surroundings by the heat insulating structure

The cooling effect obtained through the principles 1 to 3 is not necessarily satisfactory at present in the technologies which have been known.

Specifically, in the related art, in the wall structure described in JP4743365B, a white acrylic resin material is used to reflect sunlight and to radiate heat as far-infrared rays (the principles 1 and 2), and polyethylene foam is used to expect the heat insulating effect (the principle 3). However, in a case where a white acrylic resin material is used as a layer provided with a radiative cooling function, since the pigment contained in the white acrylic resin material absorbs a part of sunlight, particularly, a component in the near infrared region, it is difficult to maintain the solar reflectivity to 90% or more. Therefore, the required cooling effect cannot be obtained. In addition, in a case where polyethylene foam is used as a layer provided with a heat insulating function, far-infrared rays are reflected and scattered many times due to a large amount of bubbles contained in the polyethylene foam, and thus it is difficult to maintain the infrared transmittance to 50% or more. Therefore, the cooling effect is reduced. Furthermore, the wall structure described in JP4743365B is difficult to apply to cooling of any object to be cooled including a curved surface or unevenness.

In the technology proposed in the specification of US2015/0338175A1, a HfO₂/SiO₂/Ag lamination film is provided to reflect sunlight and to radiate heat as far-infrared rays (the principles 1 and 2), and an air layer (air gap) is provided to expect the heat insulating effect (the principle 3). However, the structure formed of the air layer (air gap) is difficult to apply to cooling of any object to be cooled including a curved surface or unevenness.

As described above, in the technologies which have been known, a technology for performing sufficient cooling on any object to be cooled including a curved surface or unevenness by utilizing radiative cooling even under direct sunlight regardless of the time of day or night has not been proposed at present.

An embodiment of the invention has been contrived in view of the above description, and an object of the invention is to provide a laminated structure which obtains an excellent cooling effect by radiative cooling even under direct sunlight regardless of the time of day or night. A task of the invention is to achieve the object.

Specific means for achieving the above-described task include the following aspects.

<1> A laminated structure comprising in this order from a side nearer to an object to be cooled: a radiative cooling layer which contains a bubble-containing resin and radiates far-infrared rays to cool the object to be cooled; and a heat insulating layer which contains a bubble-containing resin and has a porosity of 70% or more and in which the number of bubbles contained in a layer thickness direction is 8 or less.

<2> The laminated structure according to <1>, in which the radiative cooling layer has a solar reflectivity of more than 90%.

<3> The laminated structure according to <1> or <2>, in which the bubbles contained in the radiative cooling layer have a number average length of 0.1 μm or more and 20 μm or less.

<4> The laminated structure according to any one of <1> to <3>, in which the resin contained in the radiative cooling layer is polyester.

<5> The laminated structure according to <4>, in which the polyester is polyethylene terephthalate.

<6> The laminated structure according to any one of <1> to <5>, in which the heat insulating layer has a far-infrared transmittance of 50% or more.

<7> The laminated structure according to any one of <1> to <6>, in which the resin contained in the heat insulating layer is a resin selected from the group consisting of polyethylene, polypropylene, polycarbonate, and polystyrene.

<8> The laminated structure according to any one of <1> to <7>, in which the heat insulating layer is a bubble cushioning material.

<9> The laminated structure according to any one of <1> to <8>, in which the radiative cooling layer has a far-infrared emissivity of 0.6 or more.

<10> The laminated structure according to any one of <1> to <9>, in which the heat insulating layer has a far-infrared transmittance of 50% or more.

<11> The laminated structure according to any one of <1> to <10>, in which in the radiative cooling layer, the number of bubbles contained in the layer thickness direction is 10 or more.

According to an embodiment of the invention, a laminated structure which obtains an excellent cooling effect by radiative cooling even under direct sunlight regardless of the time of day or night.

### BRIEF DESCRIPTION OF THE DRAWINGS

FIG. 1 is a graph showing temperature dependency of an object to be cooled with respect to a solar reflectivity of a radiative cooling layer.

FIG. 2 is a schematic cross-sectional view showing a schematic layer structure of a laminated structure according to an embodiment of the invention.

FIG. 3 is a schematic cross-sectional view showing a schematic layer structure of a laminated structure according to another embodiment of the invention.

### DESCRIPTION OF THE PREFERRED EMBODIMENTS

Hereinafter, a laminated structure according to an embodiment of the invention will be described in detail.

In this specification, a numerical value range expressed using “to” means a range including numerical values before and after “to” as a lower limit value and an upper limit value. In the numerical value ranges described in stages in this disclosure, an upper limit value or a lower limit value of a numerical value range may be replaced with an upper limit value or a lower limit value of other numerical value ranges described in stages. In addition, in the numerical value ranges described in this disclosure, an upper limit value or a lower limit value of a numerical value range may be replaced with a value shown in examples.

In this specification, in a case where a plurality of substances corresponds to a component in a composition, the amount of the component in the composition means a total amount of the plurality of substances present in the composition, unless otherwise specified.

“Far-infrared rays” without limitation in wavelength range generally means electromagnetic waves in a wavelength range of 5 μm to 25 μm. However, from the viewpoint of exhibiting a cooling effect by radiative cooling, far-infrared rays in a wavelength range of 8 μm to 13 μm, which are easily transmitted through the atmosphere, are particularly effective. Therefore, “far-infrared rays” in this specification mean far-infrared rays in a wavelength range of at least 8 μm to 13 μm among the far-infrared rays in the above-described wavelength range.

In the invention, the far-infrared rays are also referred to as “far-infrared rays in a wavelength range of 8 μm to 13 μm” or “specific far-infrared rays” in this specification.

A laminated structure according to an embodiment of the invention includes, in this order from the side nearer to an object to be cooled, a radiative cooling layer which contains a bubble-containing resin and radiates far-infrared rays to cool an object to be cooled, and a heat insulating layer which contains a bubble-containing resin and has a porosity of 70% or more and in which the number of bubbles contained in a layer thickness direction is 8 or less.

In the laminated structure according to an embodiment of the invention, a far-infrared radiation layer may be further laminated between the radiative cooling layer and the heat insulating layer. Other layers such as an ultraviolet absorbing layer, an adhesive layer, and a latent heat storage layer may be further laminated as necessary.

The cooling structure in which the radiative cooling layer and the heat insulating layer are laminated requires a high solar reflectivity for sunlight reflection and a high far-infrared emissivity (the principles 1 and 2). The cooling structure also requires suppression of heat inflow from the surroundings by the heat insulating structure (the principle 3).

First, a total heat inflow/outflow Pₜₒₜₐₗ to/from an object to be cooled is represented by Formula (1). In Formula (1), P_{rad} is an amount of far-infrared radiation, and is represented by Formula (2).

Pₜₒₜₐₗ=P_{rad}−P_{diss}−Pₛᵤₙ (1)

P_{rad}=ε×Tᵢₙₛᵤₗₐₜᵢₒₙ×(Pₚₗₐₙₖ−P_{sky}) (2)

Pₚₗₐₙₖ represents the amount of blackbody radiation represented by Planck's formula, ε represents the emissivity of the radiative cooling layer, and Tᵢₙₛᵤₗₐₜᵢₒₙ represents the far-infrared transmittance of the heat insulating layer. P_{sky} represents the amount of far-infrared radiation from the sky, and is calculated from an empirical formula called a modified Swinbank model.

P_{diss} represents the amount of heat flowing from the surroundings via the heat insulating layer, and is calculated from the thermal resistance value of the heat insulating layer and the convective heat transfer coefficient from the outside air.

Pₛᵤₙ represents the inflow of sunlight, which is obtained by multiplying the illuminance of sunlight by the solar reflectivity of the radiative cooling layer.

From Formula (1), the temperature of the object to be cooled in thermal equilibrium, that is, the temperature of the object to be cooled in a case of Pₜₒₜₐₗ=0 is a temperature which can be lowered using the cooling structure.

Here, from Formula (1), the solar reflectivity of the radiative cooling layer necessary for cooling by radiative cooling and the infrared transmittance of the heat insulating layer under a general environment are examined by numerical calculation. In the calculation, the environmental conditions are set such that the outside air temperature is 30° C. and the humidity is 50% RH.

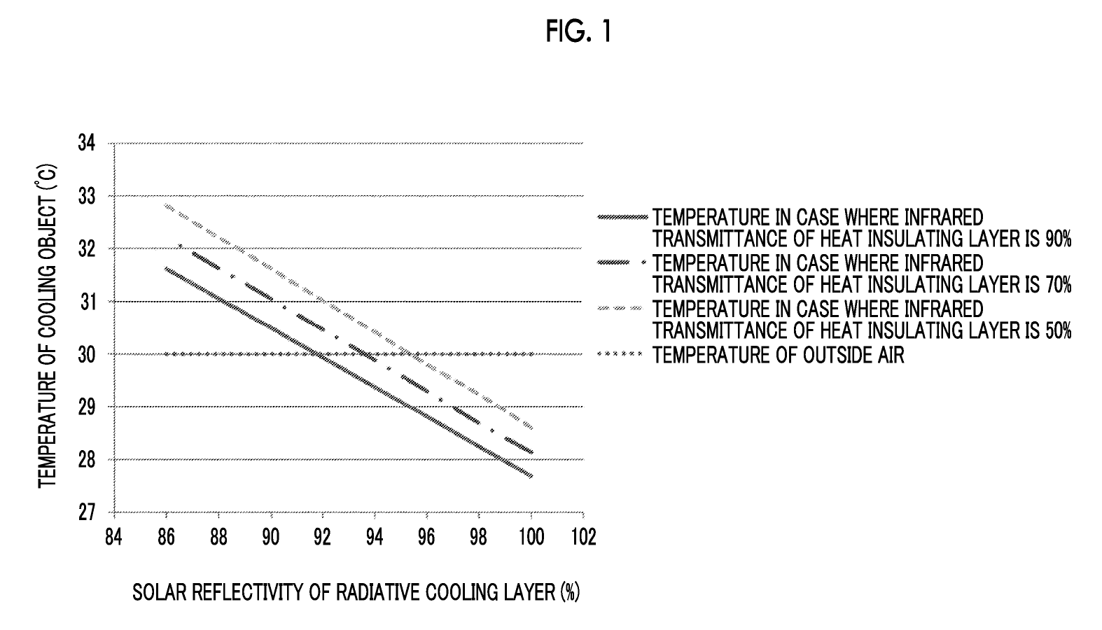

FIG. 1 shows the temperature dependency of the object to be cooled with respect to the solar reflectivity of the radiative cooling layer. The three different relation lines represent the results in a case where the heat insulating layer has a far-infrared transmittance of 90%, 70%, and 50%, respectively.

In a case where the far-infrared transmittance of the heat insulating layer is 90%, a solar reflectivity of the radiative cooling layer of more than 90% causes the temperature of the object to be cooled to decrease to a temperature lower than that of the outside air, i.e., a cooling effect is exerted. In a case where the far-infrared transmittance of the heat insulating layer is 70%, a solar reflectivity of the radiative cooling layer of more than 93% causes the temperature of the object to be cooled to decrease to a temperature lower than that of the outside air, i.e., a cooling effect is exerted. In a case where the far-infrared transmittance of the heat insulating layer is 50%, a solar reflectivity of the radiative cooling layer of more than 95% causes the temperature of the object to be cooled to decrease to a temperature lower than that of the outside air, i.e., a cooling effect is exerted..

In a case where the object to be cooled is cooled based on the principles 1 to 3, it is preferable that the far-infrared transmittance is 50% or more and the solar reflectivity of the radiative cooling layer is 90% or more.

In Patent Document 1 described above, the white acrylic resin material has a solar reflectivity of less than 90% to serve as a radiative cooling layer, and the polyethylene foam has an infrared transmittance of less than 60% to serve as a heat insulating structure. That is, in the technology described in Patent Document 1, the temperature of the object to be cooled is higher than that of the outside air, and the cooling effect is poor. Moreover, it is difficult to apply the technology described in Patent Document 1 to any object to be cooled such as a curved surface or an uneven surface.

In view of the above description, the laminated structure according to an embodiment of the invention has a radiative cooling layer which contains a bubble-containing resin and radiates far-infrared rays, and a heat insulating layer which contains a bubble-containing resin and has a porosity of 70% or more and in which the number of bubbles contained in a layer thickness direction is 8 or less.

Accordingly, the solar reflectivity of the radiative cooling layer is 90% or more. In addition, in the heat insulating layer, since the porosity due to the bubbles is 70% or more, a heat insulating function is exhibited, and since the number of bubbles in a layer thickness direction is 8 or less, scattering of far-infrared rays is suppressed, and thus the far-infrared transmittance is improved to 50% or more. As a result, it is possible to obtain a good cooling effect by radiative cooling even under direct sunlight regardless of the time of day or night.

In addition, in a case where the laminated structure is flexible, it can be applied to any object to be cooled having a curved surface or an uneven surface.

In this disclosure, the concept of the “radiative cooling” includes both a performance of actually lowering the temperature of an object to be cooled under sunlight during the day and during the night not under sunlight, and a performance of suppressing an increase in temperature of the object to be cooled under sunlight during the day and during the night not under sunlight.

The “heat insulating” means suppression of thermal conduction, and the specific thermal conductivity is not particularly limited. In this disclosure, the thermal conductivity for “heat insulating” is preferably less than 0.1 W/(m·K), and more preferably 0.08 W/(m·K) or less.

(Radiative Cooling Layer)

The radiative cooling layer contains a bubble-containing resin and radiates far-infrared rays to cool an object to be cooled. The radiative cooling layer preferably reflects sunlight and radiates far-infrared rays to cool the object to be cooled.

The radiative cooling layer may have a function of reflecting at least sunlight, or have a function of reflecting electromagnetic waves other than sunlight (for example, electromagnetic waves having a wavelength of more than 2.5 μm and less than 8 μm).

The radiative cooling layer is a resin layer having bubbles in the resin, and has a layer structure formed of a bubble-containing resin therein. Due to the bubbles contained, the radiative cooling layer can function as a white layer and have improved sunlight reflecting properties. In a case where the layer color is white, the layer generally contains a white pigment. However, in a case where the layer contains a pigment, the pigment absorbs a part of the sunlight, particularly, a component in the near infrared region, and thus the content of the pigment is preferably small from the viewpoint of the cooling effect. The content of the pigment is more preferably less than 3 mass %, and even more preferably, no pigment is contained (0 mass %).

The radiative cooling layer preferably has a solar reflectivity of more than 90%. In a case where the solar reflectivity is more than 90%, heat generation by absorption of sunlight hardly occurs, and an excellent cooling effect is obtained.

The solar reflectivity is preferably 93% or more, and more preferably 95% or more for the same reason as above.

The solar reflectivity is a value calculated based on a diffuse reflectivity measured by a spectrophotometer in accordance with the method described in JIS A 5759:2008. For measurement with a spectrophotometer, an integrating sphere spectrophotometer is used.

The radiative cooling layer preferably has a far-infrared emissivity of 0.6 or more. In a case where the far-infrared emissivity is 0.6 or more, heat release satisfactorily occurs, and a more excellent cooling effect is obtained.

The far-infrared emissivity is more preferably 0.8 or more for the same reason as above.

The far-infrared emissivity of the radiative cooling layer is a value measured by the following method.

First, a spectral transmittance and a spectral reflectivity of the radiative cooling layer at a wavelength of 1.7 μm to 25 μm are measured using a Fourier transform infrared spectroscopic analysis (FTIR) device (model number: FTS-7000) manufactured by Varian. Next, based on the measured spectral transmittance and spectral reflectivity of the radiative cooling layer, a spectral emissivity is calculated according to the following Kirchhoff's law for each of wavelengths (specifically, 10 points of 8.1 μm, 8.6 μm, 9.2 μm, 9.7 μm, 10.2 μm, 10.7 μm, 11.3 μm, 11.8 μm, 12.4 μm, and 12.9 μm; the same hereafter) included in a wavelength range of 8 μm to 13 μm in the accompanying Table 3 of JIS R 3106 (test methods for transmittance, reflectivity, emissivity, and solar radiation heat acquisition ratio of plate glasses).

Kirchhoff's Law:

Spectral Emissivity=1−Spectral Transmittance−Spectral Reflectivity

An arithmetic mean value of the spectral emissivities (10 values) for each wavelength is defined as an emissivity of the radiative cooling layer in the far-infrared wavelength range (particularly, 8 μm to 13 μm).

The bubbles in the radiative cooling layer refer to spaces existing in the resin and formed of a gas with a bubble length of 10 nm or more. The bubble length refers to the length of a line segment having the longest length among line segments connecting two points in the bubble in each bubble. The bubble length is a value measured in the same manner as in a case of the heat insulating layer.

The type of the gas may be air or another type of gas other than air, such as oxygen, nitrogen, or carbon dioxide.

The shape of the bubbles is not particularly limited, and examples thereof include various shapes such as a spherical shape, a columnar shape, an elliptical shape, a rectangular parallelepiped shape (cubic shape), and a prismatic shape.

The pressure of the gas may be an atmospheric pressure, or may be increased or decreased to be higher or lower than the atmospheric pressure. Each of the bubbles may be isolated. Otherwise, the bubbles may be partially connected to each other.

The number average length of the bubbles is preferably 0.1 μm or more and 20 μm or less. In a case where the number average length of the bubbles is within the above range, the scattering cross-sectional area is enlarged with respect to sunlight, and a high reflectivity is exhibited. Simultaneously, the scattering cross-sectional area is reduced with respect to far-infrared rays, and radiation of far-infrared rays is not inhibited. As a result, since the sunlight reflectivity and the far-infrared emissivity increase, the cooling effect by radiative cooling can be effectively increased.

Here, the number average length of the bubbles represents an average of bubble lengths of 100 bubbles.

The number average length of the bubbles is preferably 1 μm or more and 20 μm or less, and more preferably 5 μm or more and 15 μm or less.

The number average length of the bubbles is measured by the following method.

Using a microtome, the laminated structure is cut parallel to the lamination direction (that is, along the transmission direction of specific far-infrared rays) to expose a cross-section of the radiative cooling layer, and then a cross-sectional image is obtained at a magnification of 1,000 times using an electron microscope S4100 (manufactured by Hitachi High-Technologies Corporation). In the obtained cross-sectional image, the length of a line segment having the longest length among line segments connecting two points in the bubble in each bubble is defined as a bubble length.

The measurement of the bubble length described above is carried out at 100 places in the cross-sectional image, and an average of 100 measurement values is defined as the number average length of the bubbles.

The number of bubbles in the radiative cooling layer, that is, the number of bubbles traversed by a straight line in the transmission direction (contained in the layer thickness direction) in the cross-section of the radiative cooling layer cut along the transmission direction of the far-infrared rays is preferably 10 or more, and more preferably 20 or more.

In a case where the number of bubbles is 10 or more, it is advantageous in obtaining a high sunlight reflectivity.

The number of bubbles in the radiative cooling layer is a value measured in the same manner as in a case of the heat insulating layer.

The number of bubbles in the radiative cooling layer is measured by the following method.

Using a microtome, the laminated structure is cut parallel to the lamination direction (that is, along the transmission direction of specific far-infrared rays), and a cross-sectional image of the obtained cross-section is obtained at a magnification of 1,000 times using an electron microscope S4100 (manufactured by Hitachi High-Technologies Corporation). In the obtained cross-sectional image, a straight line is drawn in the transmission direction of the specific far-infrared rays, and the number of bubbles traversed by the straight line is measured (counted).

The above measurement is carried out at 100 places in the cross-sectional image, and an average of 100 measurement values is defined as the number of bubbles.

The porosity of the radiative cooling layer is preferably 10% or more and 90% or less. In a case where the porosity is 10% or more, it is advantageous in that a sufficient sunlight reflectivity can be imparted. In a case where the porosity is 90% or less, it is advantageous in that a sufficient strength can be imparted to the radiative cooling layer. The porosity of the radiative cooling layer is more preferably 20% or more and 90% or less for the same reason as above.

The porosity of the radiative cooling layer is measured by the following method.

Using a microtome, the laminated structure is cut parallel to the lamination direction (that is, along the transmission direction of specific far-infrared rays) to expose a cross-section of the radiative cooling layer, and then a cross-sectional image is obtained at a magnification of 1,000 times using an electron microscope S4100 (manufactured by Hitachi High-Technologies Corporation). In the obtained cross-sectional image, an area a of a portion corresponding to the bubbles and an area b of a portion corresponding to the cross-section excluding the bubbles are measured to obtain the porosity of the radiative cooling layer by the following calculation formula.

Porosity(%)=(area a/(area a+area b))×100

The porosity is calculated using a cross-sectional image corresponding to an actual area of 500 mm² of the cross-section of the radiative cooling layer.

The bubbles may be distributed uniformly or in only a part in the layer thickness direction of the radiative cooling layer.

The resin contained in the radiative cooling layer can be selected according to the purpose from resin materials having small absorption of sunlight and large radiation of far-infrared rays.

Examples of the resin include polyolefin (polyethylene, polypropylene, poly(4-methylpentene-1), and polybutene-1), polyester (polyethylene terephthalate and polyethylene naphthalate), polycarbonate, polyvinyl chloride, polyphenylene sulfide, polyether sulfone, polyethylene sulfide, polyphenylene ether, polystyrene, acrylic resin, polyamide, polyimide, and cellulose such as cellulose acetate.

Among these, polyester is preferable, and polyethylene terephthalate (PET) is particularly preferable as the resin due to excellent workability and optical characteristics.

PET is excellent in workability and easily forms bubbles. In addition, PET has excellent optical characteristics, and can increase the far-infrared radiation performance while suppressing sunlight absorption. Therefore, PET is more suitable for the cooling effect.

The amount of the resin in the radiative cooling layer can be set within a range of 50 mass % to 100 mass % with respect to the total solid content of the radiative cooling layer.

As the radiative cooling layer, commercially available products which are on the market may be used. Examples of the commercially available products include ultrafine foamed light reflection plates of MCPET series (for example, MCPET M4 and MCPET RB) and MCPOLYCA series (for example, MCPET YM) manufactured by Furukawa Electric Co., Ltd., and white polyethylene terephthalate (PET) films (for example, LUMIRROR E20, E22, E28G, and E60) manufactured by TORAY INDUSTRIES, INC.

The thickness of the radiative cooling layer is preferably 10 μm or more and 10,000 μm or less, and more preferably 20 μm or more and 5,000 μm or less. It is preferable that the thickness is within the above range since it is possible to achieve a sufficient sunlight reflectivity while maintaining flexibility of the radiative cooling layer.

(Heat Insulating Layer)

The heat insulating layer contains a bubble-containing resin and has a porosity of 70% or more. In addition, the number of bubbles contained in a layer thickness direction is 8 or less. In a case where the porosity of the heat insulating layer and the number of bubbles are within the above ranges, an excellent cooling effect is obtained. The heat insulating layer can be appropriately selected according to the purpose as long as it transmits far-infrared rays, and transmits or reflects sunlight.

Here, the bubbles in the heat insulating layer refer to spaces existing in the resin and formed of a gas with a bubble length of 10 nm or more. The bubble length refers to the length of a line segment having the longest length among line segments connecting two points in the bubble in each bubble. The bubble length is a value measured by a method to be described later.

The type of the gas may be air or another type of gas other than air, such as oxygen, nitrogen, or carbon dioxide.

The shape of the bubbles is not particularly limited, and examples thereof include various shapes such as a spherical shape, a columnar shape, an elliptical shape, a rectangular parallelepiped shape (cubic shape), and a prismatic shape.

The pressure of the gas may be an atmospheric pressure, or may be increased or decreased to be higher or lower than the atmospheric pressure. Each of the bubbles may be isolated. Otherwise, the bubbles may be partially connected to each other.

The porosity of the heat insulating layer is 70% or more. In a case where the porosity is 70% or more, thermal conduction by a portion other than air is prevented from being increased, and the heat insulating effect can be easily maintained favorably.

The porosity is preferably 80% or more, and more preferably 90% or more for the same reason as above. The upper limit of the porosity can be set to 98%.

The porosity of the heat insulating layer is a value measured by the following method.

Using a microtome, the laminated structure is cut parallel to the lamination direction to expose a cross-section of the heat insulating layer, and then a cross-sectional image is obtained at a magnification of 10 times using an optical microscope ME600L (manufactured by Nikon Corporation). In the obtained cross-sectional image, an area a of a portion corresponding to the bubbles and an area b of a portion corresponding to the cross-section excluding the bubbles are measured to obtain the porosity of the heat insulating layer by the following calculation formula.

Porosity(%)of Heat Insulating Layer=(area a/(area a+area b))×100

The porosity is calculated using a cross-sectional image corresponding to an actual area of 500 mm² of the cross-section of the heat insulating layer.

The number of bubbles in the layer thickness direction of the heat insulating layer is 8 or less. That is, the number of bubbles traversed by a straight line in the transmission direction in the cross-section of the heat insulating layer cut along the transmission direction of the far-infrared rays (specific far-infrared rays) in a wavelength range of 8 μm to 13 μm is 8 or less. In a case where the number of bubbles is 8 or less, scattering of far-infrared rays is suppressed, and thus the far-infrared transmittance, that is, the radiative cooling performance is improved.

In many cases, the resin has a refractive index of about 1.5 in the far-infrared region, and thus far-infrared rays which are lost by reflection at interfaces between the resin and the bubbles are about 4%. The reflection occurs two times for each bubble, and thus in a case where the number of bubbles is more than 9, the far-infrared transmittance becomes smaller than 50%. That is, the radiative cooling effect cannot be obtained.

The number of bubbles is preferably 7 or less from the same viewpoint as above. The lower limit of the number of bubbles can be 1 or more, and is preferably 2 or more.

The number of bubbles means a value measured as follows.

That is, the laminated structure (specifically, heat insulating layer) is cut along the transmission direction of specific far-infrared rays using a microtome, and a cross-sectional image of the obtained cross-section is obtained using a microscope (magnification: 10 times). In the obtained cross-sectional image, a straight line is drawn in the transmission direction of the specific far-infrared rays, and the number of bubbles traversed by the straight line is measured (counted).

The above measurement is carried out at 100 places in the cross-sectional image, and an average of 100 measurement values is defined as the number of bubbles.

The number average length of the bubbles contained in the heat insulating layer is preferably 1 mm or more. Due to this, the number of times of scattering of the specific far-infrared rays and/or the number of times of reflection are reduced, and thus the transmittance for the specific far-infrared rays is further improved.

In a case where the number average length of the bubbles is 1 mm or more, the number average length of the bubbles is more preferably 1 mm to 50 mm, even more preferably 1 mm to 30 mm, and particularly preferably 1 mm to 20 mm.

The number average length of the bubbles contained in the heat insulating layer represents an average of bubble lengths of 100 bubbles.

The bubble length and the number average length of the bubbles are values measured as follows.

That is, using a microtome, the laminated structure (specifically, heat insulating layer) is cut parallel to the lamination direction, and from the cut surface, a cross-sectional image is obtained at a magnification of 10 times using an optical microscope ME600L (manufactured by Nikon Corporation). In the obtained cross-sectional image, the length of a line segment having the longest length among line segments connecting two points in the bubble in each bubble is defined as a bubble length.

The measurement of the bubble length described above is carried out at 100 places in the cross-sectional image, and an average of 100 measurement values is defined as the number average length of the bubbles.

The far-infrared transmittance of the heat insulating layer is preferably 50% or more. In a case where the far-infrared transmittance of the heat insulating layer is 50% or more, the far-infrared transmittance in the heat insulating layer increases, and thus the cooling effect by radiative cooling is further increased.

The far-infrared transmittance is more preferably 70% or more, and even more preferably 80% or more.

The far-infrared transmittance of the heat insulating layer means an arithmetic mean value of spectral transmittance at wavelengths included in a wavelength range of 8μm to 13 μm in the accompanying Table 3 of JIS R 3106 (1998), and is measured by the following method.

In order to measure the far-infrared transmittance, a spectral transmittance in a wavelength range of 1.7 μm to 25 μm is measured using a Fourier transform infrared spectroscopic analysis (FTIR) device (model number: FTS-7000) manufactured by Varian.

Among the results of the measurement of the spectral transmittance in a wavelength range of 1.7 μm to 25 μm, spectral transmittance values (10 values) at wavelengths (specifically, 10 wavelength points of 8.1 μm, 8.6 μm, 9.2 μm, 9.7 μm, 10.2 μm, 10.7 μm, 11.3 μm, 11.8 μm, 12.4 μm, and 12.9 μm) included in a wavelength range of 8 μm to 13 μm in the accompanying Table 3 of JIS R 3106 (1998) are arithmetically averaged to obtain the far-infrared transmittance.

The material for forming the heat insulating layer is preferably a resin material having a high far-infrared transmittance.

Specific examples thereof include resin materials such as polyethylene, polypropylene, polycarbonate, polystyrene, and polynorbornene. Particularly, polyethylene is preferable from the viewpoint of excellent workability.

The material for forming the heat insulating layer may contain a mixture of two or more types of the resin materials described above according to the purpose, and unavoidable impurities may be contained as long as the impurities do not affect the far-infrared transmittance.

Specific examples of the heat insulating layer exhibiting the above-described characteristics include a bubble cushioning material.

The bubble cushioning material refers to, for example, a material in which one or more chambers with air trapped therein are present in the surface direction. In a case where the bubble cushioning material is used, the number of times of scattering of far-infrared rays in the heat insulating layer is reduced. In other words, the far-infrared transmittance in the heat insulating layer increases, and the cooling effect by radiative cooling is increased.

Examples of the bubble cushioning material include commercially available products which are on the market, such as AIR CAP (registered trademark, manufactured by Sakai Chemical Group), PUTIPUTI (registered trademark, manufactured by Kawakami Sangyo Co., Ltd., for example, d35 and d42), MINAPACK (registered trademark, manufactured by Sakai Chemical Group), and CAPRON (registered trademark, manufactured by JSP).

The thickness of the heat insulating layer is preferably 1 mm or more and 50 mm or less, and more preferably 2 mm or more and 25 mm or less. The thickness of the heat insulating layer is preferably 1 mm or more since the heat insulating effect is secured. In addition, in a case where the thickness of the heat insulating layer is 50 mm or less, sufficient flexibility can be imparted to the heat insulating layer.

(Other Layers)

The laminated structure according to an embodiment of the invention may have a far-infrared radiation layer in addition to the radiative cooling layer and the heat insulating layer described above, and may further optionally have other layers according to the purpose. Examples of other layers include a latent heat storage layer, an ultraviolet (UV) absorbing layer, and an adhesive layer.

—Far-Infrared Radiation Layer—

A far-infrared radiation layer can be provided between the radiative cooling layer and the heat insulating layer.

By providing the far-infrared radiation layer, it is possible to further improve the performance of radiating specific far-infrared rays at a wavelength of 8 μm to 13 μm.

The far-infrared radiation layer is preferably provided as a layer which has a sunlight absorbance of 10% or less and in which an emissivity for specific far-infrared rays is 50% or more at a wavelength of 8 μm to 13 μm.

In the far-infrared radiation layer, an average emissivity in a wavelength range of 8 μm to 13 μm in a radiation direction of specific far-infrared rays is preferably 0.80 or more, more preferably 0.85 or more, and particularly preferably 0.90 or more.

In a case where the average emissivity of the far-infrared radiation layer is 0.80 or more, the far-infrared radiation performance of the far-infrared radiation layer at a wavelength of 8 μm to 13 μm is further improved, and thus the radiative cooling performance is further improved.

The average emissivity of the far-infrared radiation layer is a value measured by the same method as in the measurement of the infrared emissivity of the radiative cooling layer described above.

The far-infrared radiation layer is not particularly limited in structure, and can be selected according to the purpose or the like so as to have any form such as a single layer film, a multilayer film, a fine particle dispersion structure, or a structure containing bubbles.

As the material for forming the far-infrared radiation layer, a resin is preferably used from the viewpoint of excellent flexibility and increasing the far-infrared emissivity.

Examples of the resin include polyolefin (for example, polyethylene, polypropylene, poly(4-methylpentene-1), and polybutene-1), polyester (for example, polyethylene terephthalate and polyethylene naphthalate), polycarbonate, polyvinyl chloride, polyphenylene sulfide, polyether sulfone, polyethylene sulfide, polyphenylene ether, polystyrene, acrylic resin, polyamide, polyimide, and cellulose such as cellulose acetate.

It is also preferable to provide an adhesive for bonding the radiative cooling layer to the heat insulating layer as the far-infrared radiation layer.

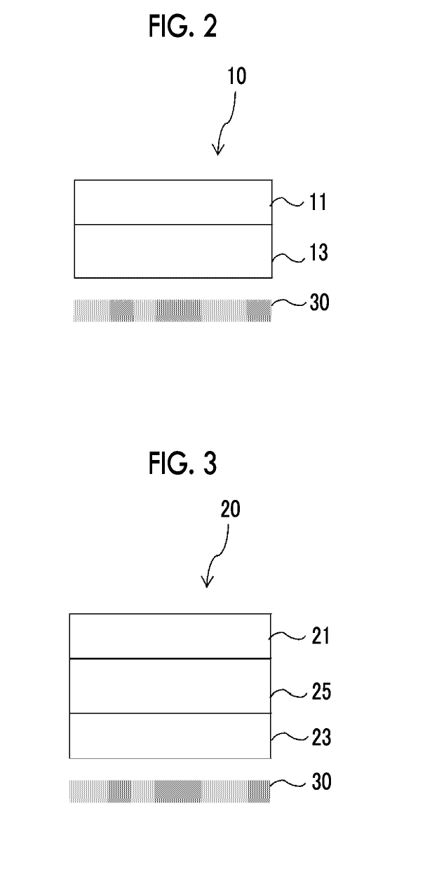

Here, embodiments of the laminated structure according to the embodiment of the invention are shown in FIGS. 2 and 3.

The laminated structure may have a two-layer structure as shown in FIG. 2. In a laminated structure 10, a radiative cooling layer 13 and a heat insulating layer 11 are laminated in this order from the side of an object 30 to be cooled, and by providing the laminated structure 10 on the object 30 to be cooled, radiative cooling is performed while absorption of sunlight is suppressed in the object to be cooled. Specifically, far-infrared rays having a wavelength of at least 8 μm to 13 μm are radiated from the radiative cooling layer 13 and pass through the heat insulating layer, and heat inflow from the outside is suppressed in the heat insulating layer. Thus, the object 30 to be cooled is cooled. The laminated structure 10 may be just provided on a surface of the object 30 to be cooled, or adhered to the surface of the object to be cooled.

The laminated structure may have a three-layer structure as shown in FIG. 3. In a laminated structure 20, a radiative cooling layer 23, a far-infrared radiation layer 25, and a heat insulating layer 21 are laminated in this order from the side of an object 30 to be cooled. By providing the laminated structure 20 on the object 30 to be cooled, radiative cooling is effectively performed while absorption of sunlight is suppressed in the object to be cooled. In the three-layer structure in which the far-infrared radiation layer 25 is further provided, the object to be cooled is cooled in the same manner as in the above-described two-layer structure, and a more excellent cooling effect is obtained since the far-infrared radiation layer 25 is provided. The laminated structure 20 may be just provided on a surface of the object 30 to be cooled, or adhered to the surface of the object to be cooled.

### EXAMPLES

Hereinafter, the invention will be described in more detail with examples, but is not limited to the following examples unless departing from the gist thereof. Unless otherwise specified, “part” is on a mass basis.

In the examples, a spectrophotometer V-670 manufactured by JASCO Corporation was used as a spectrophotometer for use in the measurement of a solar reflectivity.

### Example 1

A white polyethylene terephthalate (PET) sheet (MCPET M4 (thickness: 1.0 mm, manufactured by Furukawa Electric Co., Ltd.)) was prepared as a radiative cooling layer, and a bubble cushioning material (bubble length: 10 mm, thickness: 3.5 mm; d42, manufactured by Kawakami Sangyo Co., Ltd.) as a heat insulating layer was bonded to the PET sheet using an adhesive (GP Clear, manufactured by Konishi Co., Ltd.) to produce a laminated structure.

### Example 2

A white polyethylene terephthalate (PET) film (thickness: 75 μm, LUMIRROR (registered trademark) E60, manufactured by manufactured by TORAY INDUSTRIES, INC.) was prepared as a radiative cooling layer, and a bubble cushioning material (d42, manufactured by Kawakami Sangyo Co., Ltd.) as a heat insulating layer was bonded to the PET film using an adhesive (GP Clear, manufactured by Konishi Co., Ltd.) to produce a laminated structure.

### Example 3

A white polyethylene terephthalate (PET) sheet (MCPET M4 (thickness: 1.0 mm, manufactured by Furukawa Electric Co., Ltd.)) was prepared as a radiative cooling layer, and two bubble cushioning materials (d42, manufactured by Kawakami Sangyo Co., Ltd.) as a heat insulating layer were stacked and bonded to the PET sheet using an adhesive (GP Clear, manufactured by Konishi Co., Ltd.) to produce a laminated structure.

The same adhesive (GP Clear, manufactured by Konishi Co., Ltd.) was also used to bond the two bubble cushioning materials to each other.

### Example 4

A white polyethylene terephthalate (PET) film (thickness: 75 μm, LUMIRROR (registered trademark) E60, manufactured by manufactured by TORAY INDUSTRIES, INC.) was prepared as a radiative cooling layer, and two bubble cushioning materials (d42, manufactured by Kawakami Sangyo Co., Ltd.) as a heat insulating layer were stacked and bonded to the PET film using an adhesive (GP Clear, manufactured by Konishi Co., Ltd.) to produce a laminated structure.

The same adhesive (GP Clear, manufactured by Konishi Co., Ltd.) was also used to bond the two bubble cushioning materials to each other.

### Comparative Example 1

A transparent polyethylene terephthalate (transparent PET) film (LUMIRROR T60, manufactured by TORAY INDUSTRIES, INC., thickness=100 μm) was prepared, and an acrylic white paint (Super Coat White, manufactured by ASAHIPEN CORPORATION) was applied to a surface of the transparent PET film by spraying. A polyethylene foam (FOAM ACE, manufactured by Furukawa Electric Co., Ltd.) having a thickness of 10 mm as a heat insulating layer was bonded to the coated surface using an adhesive (GP Clear, manufactured by Konishi Co., Ltd.) to produce a laminated structure.

### Comparative Example 2

A white polyethylene terephthalate (PET) sheet (MCPET M4 (thickness: 1.0 mm, manufactured by Furukawa Electric Co., Ltd.)) was prepared as a radiative cooling layer, and a polyethylene foam (FOAM ACE, manufactured by Furukawa Electric Co., Ltd.) having a thickness of 10 mm as a heat insulating layer was bonded to the PET sheet using an adhesive (GP Clear, manufactured by Konishi Co., Ltd.) to produce a laminated structure.

(Measurement and Evaluation)

The following measurement and evaluation were performed on the laminated structures produced in the examples and the comparative examples. The results of the measurement and the evaluation are shown in Table 1.

—1. Solar Reflectivity of Radiative Cooling Layer—

A solar reflectivity was calculated based on a diffuse reflectivity measured by a spectrophotometer V-670 (manufactured by JASCO Corporation; integrating sphere spectrophotometer) in accordance with the method described in JIS A 5759:2008.

—2. Number Average Length of Bubbles of Radiative Cooling Layer—

Using a microtome, the laminated structure was cut parallel to the lamination direction to expose a cross-section of the radiative cooling layer, and then a cross-sectional image was obtained at a magnification of 1,000 times using an electron microscope S4100 (manufactured by Hitachi High-Technologies Corporation). In the obtained cross-sectional image, the length of a line segment having the longest length among line segments connecting two points in the bubble in each bubble was defined as a bubble length.

The measurement of the bubble length described above was carried out at 100 places in the cross-sectional image, and an average of 100 measurement values was defined as the number average length of the bubbles.

—3. Far-Infrared Emissivity of Radiative Cooling Layer at Wavelength of 8 μm to 13 μm—

First, a spectral transmittance and a spectral reflectivity of the radiative cooling layer at a wavelength of 1.7 μm to 25 μm were measured using a Fourier transform infrared spectroscopic analysis (FTIR) device (model number: FTS-7000) manufactured by Varian. Next, based on the measured spectral transmittance and spectral reflectivity of the radiative cooling layer, a spectral emissivity was calculated according to the following Kirchhoff's law for each of wavelengths (specifically, 10 points of 8.1 μm, 8.6 μm, 9.2 μm, 9.7 μm, 10.2 μm, 10.7 μm, 11.3 μm, 11.8 μm, 12.4 μm, and 12.9 μm; the same hereafter) included in a wavelength range of 8μm to 13 μm in the accompanying Table 3 of JIS R 3106 (test methods for transmittance, reflectivity, emissivity, and solar radiation heat acquisition ratio of plate glasses).

Kirchhoff's Law:

Spectral Emissivity=1−Spectral Transmittance−Spectral Reflectivity

An arithmetic mean value of the spectral emissivities (10 values) for each wavelength was defined as an average emissivity of the radiative cooling layer in a wavelength range of 8 μm to 13 μm.

—4. Porosity of Heat Insulating Layer—

Using a microtome, the laminated structure was cut parallel to the lamination direction to expose a cross-section of the heat insulating layer, and then a cross-sectional image was obtained at a magnification of 10 times using an optical microscope ME600L (manufactured by Nikon Corporation). In the obtained cross-sectional image, an area a of a portion corresponding to the bubbles and an area b of a portion corresponding to the cross-section excluding the bubbles were measured to obtain the porosity of the heat insulating layer by the following calculation formula.

Porosity(%)of Heat Insulating Layer=(area a/(area a+area b))×100

The porosity was calculated using a cross-sectional image corresponding to an actual area of 500 mm² of the cross-section of the heat insulating layer.

—5. Number of Bubbles in Layer Thickness Direction of Heat Insulating Layer—

Using a microtome, the laminated structure was cut parallel to the lamination direction to expose a cross-section of the heat insulating layer, and then a cross-sectional image was obtained at a magnification of 10 times using an optical microscope ME600L (manufactured by Nikon Corporation). In the obtained cross-sectional image, a straight line was drawn in the layer thickness direction of the heat insulating layer, and the number of bubbles traversed by the straight line was measured (counted). This operation was carried out at 100 places in the cross-sectional image, and an average of 100 measurement values was defined as the number of bubbles.

—6. Measurement of Far-Infrared Transmittance of Heat Insulating Layer—

A spectral transmittance of the heat insulating layer was measured at a wavelength of 1.7 μm to 25 μm using a Fourier transform infrared spectroscopic analysis (FTIR) device (model number: FTS-7000) manufactured by Varian.

Among the results of the measurement of the spectral transmittance in a wavelength range of 1.7 μm to 25 μm, spectral transmittance values (10 values) at wavelengths (specifically, 10 wavelength points of 8.1 μm, 8.6 μm, 9.2 μm, 9.7 μm, 10.2 μm, 10.7 μm, 11.3 μm, 11.8 μm, 12.4 μm, and 12.9 μm) included in a wavelength range of 8 μm to 13 μm in the accompanying Table 3 of JIS R 3106 (1998) were arithmetically averaged to obtain the far-infrared transmittance.

—7. Heat Insulating Properties—

The laminated structures produced in Examples 1 to 4 and Comparative Examples 1 and 2 were used, and temperatures of the laminated structures were measured for 30 minutes with a K-type thermocouple in an outdoor place exposed to direct sunlight to obtain an average temperature 1. In addition, a temperature of the outside air was measured with a thermometer to obtain an average temperature 2.

The measured average temperature 1 and average temperature 2 were compared to evaluate the heat insulating properties of the laminated structure with a temperature difference between the average temperature 1 and the average temperature 2 (average temperature 1-average temperature 2) as an index. It can be said that the laminated structure has excellent heat insulating properties as the average temperature 1 of the laminated structure is lower than the average temperature 2 of the outside air and the temperature difference is large.

TABLE 1

| | Radiative Cooling Layer | | | | Heat Insulating Layer | | | | | Evaluation of Heat Insulating Properties | | |
|---|---|---|---|---|---|---|---|---|---|---|---|---|
| | Number | | | Far- | | Number of | Far- | | | | Temperature | |
| | Average | | Solar | Infrared | | Bubbles in | Infrared | | | Temperature | of Laminated | Temperature |
| | Length of | | Reflec- | Emis- | | Layer Thickness | Transmit- | Thick- | | of Outside Air | Structure | Difference |
| | Bubbles | | tivity | sivity | Porosity | Direction | tance | ness | | [° C.] | [° C.] | [° C.] |
| Example 1 | 10 | μm | 97% | 0.84 | 90% | 1 | 72% | 3.5 | mm | 30 | 27 | −3 |
| Example 2 | 5 | μm | 93% | 0.87 | 90% | 1 | 72% | 3.5 | mm | 30 | 28 | −2 |
| Example 3 | 10 | μm | 97% | 0.84 | 90% | 2 | 65% | 7 | mm | 30 | 26 | −4 |
| Example 4 | 5 | μm | 93% | 0.87 | 90% | 2 | 65% | 7 | mm | 30 | 27 | −3 |
| Comparative | — | | 86% | 0.85 | 80% | 120 | 5% | 10 | mm | 30 | 34 | 4 |
| Example 1 | | | | | | | | | | | | |
| Comparative | 10 | μm | 97% | 0.84 | 80% | 120 | 5% | 10 | mm | 30 | 32 | 2 |
| Example 2 | | | | | | | | | | | | |

As shown in Table 1, it is found that the laminated structures of Examples 1 to 4 have a lower temperature than the outside air and a heat insulating effect is exhibited.

In contrast, as shown in Comparative Examples 1 and 2, in a case where either one or both of the condition that the number of bubbles contained in the thickness direction of the heat insulating layer is 8 or less and the condition that the solar reflectivity of the radiative cooling layer is more than 90% are not satisfied, the temperature of the laminated structure was higher than that of the outside air, and no heat insulating effect was exhibited.

The entire disclosure of JP2016-194975 filed on Sep. 30, 2016 is incorporated herein by reference.

All publications, patent applications, and technical standards mentioned in this specification are incorporated herein by reference to the same extent as if each individual publication, patent application, or technical standard was specifically and individually indicated to be incorporated by reference.

What is claimed is:

1. A laminated structure comprising in this order from a side nearer to an object to be cooled:
a radiative cooling layer which contains a bubble-containing resin and radiates far-infrared rays to cool the object to be cooled; and
a heat insulating layer which contains a bubble-containing resin and has a porosity of 70% or more and in which the number of bubbles contained in a layer thickness direction is 8 or less.

2. The laminated structure according to claim 1, wherein the radiative cooling layer has a solar reflectivity of more than 90%.

3. The laminated structure according to claim 1, wherein bubbles contained in the radiative cooling layer have a number average length of 0.1 μm to 20 μm.

4. The laminated structure according to claim 1, wherein the resin contained in the radiative cooling layer is polyester.

5. The laminated structure according to claim 4, wherein the polyester is polyethylene terephthalate.

6. The laminated structure according to claim 1, wherein the heat insulating layer has a far-infrared transmittance of 50% or more.

7. The laminated structure according to claim 1, wherein the resin contained in the heat insulating layer is a resin selected from the group consisting of polyethylene, polypropylene, polycarbonate, and polystyrene.

8. The laminated structure according to claim 1, wherein the heat insulating layer comprises a bubble cushioning material.

9. The laminated structure according to claim 1, wherein the radiative cooling layer has a far-infrared emissivity of 0.6 or more.

10. The laminated structure according to claim 1, wherein the heat insulating layer has a far-infrared transmittance of 50% or more.

11. The laminated structure according to claim 1, wherein in the radiative cooling layer, the number of bubbles contained in the layer thickness direction is 10 or more.

12. The laminated structure according to claim 1, wherein a porosity of the radiative cooling layer is from 10% to 90%.

13. The laminated structure according to claim 1, wherein a number average length of bubbles contained in the heat insulating layer is from 1 mm to 50 mm
